(19) United States
(12) Patent Application Publication
(10) Pub. No.: US 2007/0029056 A1
(43) Pub. Date: Feb. 8, 2007

(54) Pull cord activation passage mechanism for a window blind

(75) Inventors: Hsien-Te Huang, Taipei (TW); Wen-Ying Liang, Chang-Hwa (TW); Sheng-Ying Hsu, Chang-Hwa (TW)

Correspondence Address: TROXELL LAW OFFICE PLLC, SUITE 1404, 5205 LEESBURG PIKE, FALLS CHURCH, VA, 22041, US

(73) Assignee: Ching Feng Home Fashions Co., Ltd.

(21) Appl. No.: 11/196,433

(22) Filed: Aug. 4, 2005

(51) Int. Cl. E06B 9/30

(52) U.S. Cl. 160/168.1 R

(57) ABSTRACT

A pull cord activation passage mechanism for a window blind, which is particularly used for providing a reaction length of a longer curvature in a passage of activating a pull cord for driving curtains of a horizontal blind, and for enabling the pull cord to enter into related sliding members in a nearly perpendicular direction, in order to enable an arresting member to be close to a first pull cord seat, comprises primarily a bending pulley located between a first and a second seats for providing a turning back of the first pull cord. An open ring is located on the seat, for providing sliding members to adjust corresponding to a pulling angle of the pull cord, thereby avoiding impedance in a slant direction, and enabling a smooth operation to the pull cord.

### BACKGROUND OF THE INVENTION

(a) Field of the Invention

The present invention relates to an improved mechanism of a pull cord activation passage for a window blind, and more particularly to a pull cord activation passage that provides a driving to curtains of a horizontal window blind, so as to acquire a change to a longer curvature for facilitating an installation of an arresting member close to a first seat, thereby increasing a reserved cutting length. In addition, the pull cord can provide a sliding member to change in corresponding to a pulling angle of the pull cord through an open ring, so as to enable a smooth operation to the entire device.

(b) Description of the Prior Art

Referring to FIG. 4, it shows a window blind wherein a pull cord is used to activate curtains. The window blind comprises primarily a top rail 1 whose bottom is connected with curtains 11 which can be pulled up after being connected with a bottom rail 10 through a pull cord 4.

The pull cord 4 is turned to an arresting member 3 through a seat 2, and a free end is accumulated to constitute an active pull cord 40. A two-point balance is obtained for the pull cord 4 based on a width of the curtain 11. There are at least two strings of pull cords 4 which are passed through each perforation 110 installed on the curtains 11, and then passed around a first seat 2A and a second seat 2B.

After being accumulated and cut into the arresting member 3, the free end is extended downward to constitute the active pull cord 40 which is used to provide a user to operate by hands.

Moreover, the first and second seats 2A, 2B are connected with a transmission turning member 22 through a transmission shaft 220. A front and back sides of the turning member 22 are connected with cords 221 which are operated by an actuating member 21 through the transmission shaft 220, so as to enable the turning member 22 to adjust the cords at the front and back sides, thereby changing an angle of shading of the curtains 11. The actuating member 21 is turned by an operation of a hand rod 210.

The arresting member 3 can lock sections of pull cords 4 accumulated at each fixed point, so as to enable the bottom rail 10 to be fixed at any horizontal height. However, a certain distance should be reserved between the arresting member 3 and the first seat 2A, so as to enable the pull cord 4 entering the first seat 2A to acquire a longer curvature, thereby smoothly pulling the active pull cord 40.

Referring to FIG. 2, a plurality of seats 2A, 2B are distributed along an axis inside the top rail 1. Each seat is provided with a through-hole 23 at a center, in order to provide a passage to the aforementioned pull cord 4. In responding to a requirement of width of the entire blind, a cutting length L is reserved at an end (right end) of the top rail 1. The way of reservation is to put the arresting member 3 to be as close to a side of the first seat 2A as possible, so as to provide for the maximum cutting length L.

According to different seats, the pull cord 4 can be divided into a first pull cord 41, a second pull cord 42, and a third pull cord 43. As the arresting member 3 should be operated indoors, it should be installed at a side 100 of the top rail 1 facing an interior of a room. Therefore, there is a significant slant angle between the pull cord 41 of the first seat 2A and the arresting member 3, such that when the first pull cord 41 is going to pass into the arresting member 3, it will be restricted by an inner side-plate 33 of the arresting member 3, and its edge will be rubbed against and even stopped by a corner 330 formed thereby. However, as the second and the third pull cords 42, 43 are at locations farther from the arresting member 3, their slant angles are not significant.

As shown in FIG. 2, in a conventional design, a larger cutting length L is reserved at a right end of the top rail 1, which will significantly create a friction between the pull cord 41 and the corner 330 of the arresting member 3, and will be unable to successfully pull the cord 41.

After all the pull cords 4 are accumulated and passed through the arresting member 3, they are turned and extended downward through a pulley 32 with one side being locked by a latching member 31, so as to acquire the aforementioned positioning of horizontal height.

Referring to FIG. 3, it shows a conventional blind using two pull cords at a front and a rear side. In order to reserve for the cutting length L, the arresting member 3 is put to be close to the first seat 2A. Through-holes 23 are located in a front and a rear end of the first and second seat 2A, 2B, respectively, so as to provide for passing through the pull cords 41A, 41B, 42A, 42B at the front and rear side. From the first seat 2A, it can clearly show that a significant friction is created between the first pull cord 41A and the corner 330 of the arresting member 3.

As the size of arresting member 3 cannot be enlarged due to a restriction of structure, and the inner side-plate 33 must be available; therefore, the corner 330 will significantly interfere with a passage route of the first pull cord 41A, thereby creating a friction.

Referring to FIG. 4, as the arresting member 3 has a certain height; therefore, if it is against the first seat 2A, a significant angle of elevation will be formed in order to pass the pull cord 4 into the pulley 32, prior to passing the pull cord 41 into the arresting member 3.

On the other hand; the second pull cord 42 does not have a significant angle. However, as the two cords must be raised in a slant direction, they will touch lower edges of the turning members 22 located inside the seats 2A, 2B, thereby causing a significant interference.

As shown in FIG. 2, sliding members 231 should be installed at openings of the through-holes 23 of the seats 2A, 2B, in order to provide a sliding to the pull cords 41, 42, thereby reducing a restriction to bending.

The sliding member 231 is formed with a fixed angle due to a mass production, and as a significant slant angle is formed between the first pull cord 41 and the arresting member 3, impedance in a slant direction is created between the sliding member 231 and the first pull cord 41. As the pull cord is made of a firm material, a continuous bending within a short distance will accumulate stress in multiple angles, and thus cause non-smoothness. Therefore, an absorption by a strain length R should be depended on, in that if the strain length R is longer, it will facilitate a conversion of torsion stress to form wave energy, and to release the torsion stress by the wave. However, in a conventional design, the strain length R is apparently reduced, thereby causing interference to pulling.

### SUMMARY OF THE INVENTION

In lieu of the aforementioned shortcomings, the present invention uses a bending pulley between the first and second seats, to provide a longer reaction length to a section of the first pull cord, and to enable the pull cord to have a smooth angle in passing in all the elements, thereby providing a smooth sliding and pulling to the curtains.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of a blind structure having pull cords.

FIG. 2 shows a top view of a conventional blind element having a reserved cutting length.

FIG. 3 shows a top view of a blind structure having two pull cords.

FIG. 4 shows a front view of major elements of a conventional blind.

FIG. 5 shows a top view of structure of the present invention.

FIG. 6 shows a schematic view of another implementation of FIG. 5.

FIG. 7 shows a top view of position change of an arresting member of the present invention.

FIG. 8 shows a perspective view of a seat whose bottom is provided with an open ring of the present invention.

FIG. 9 shows a top view of FIG. 8.

FIG. 10 shows a schematic view of an implementation of FIG. 9.

FIG. 11 shows a schematic view of a second implementation of FIG. 9.

FIG. 12 shows a schematic view of adjusting an angle of a shaft-shape sliding member.

FIG. 13 shows another schematic view of adjusting an angle of a shaft-shape sliding member.

FIG. 14 shows a schematic view that a shaft-shape sliding member provides a reserved height to a pull cord.

FIG. 15 shows a schematic view of another implementation of FIG. 14.

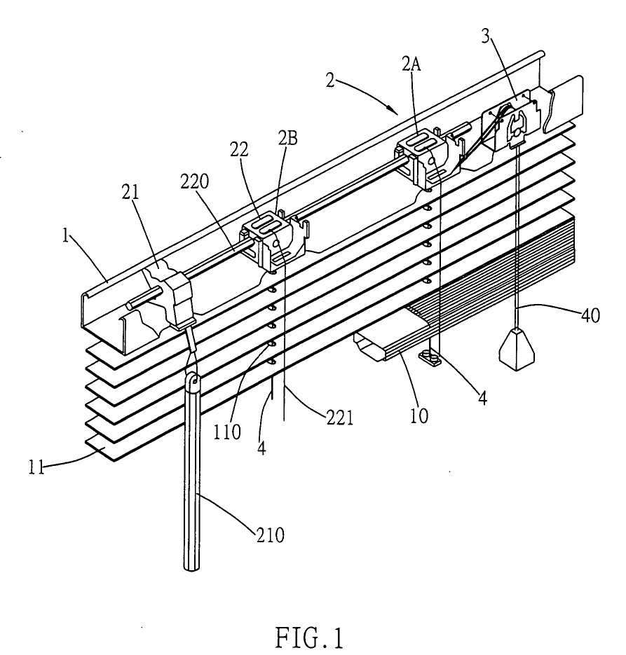

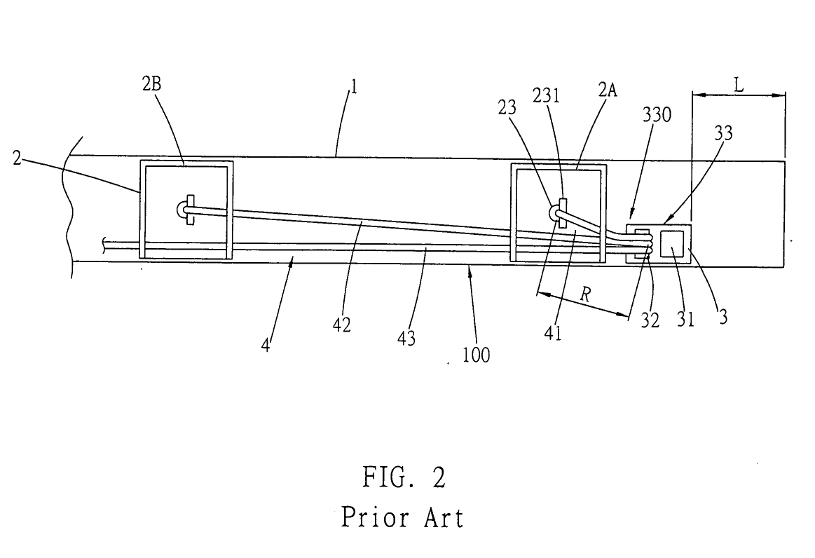

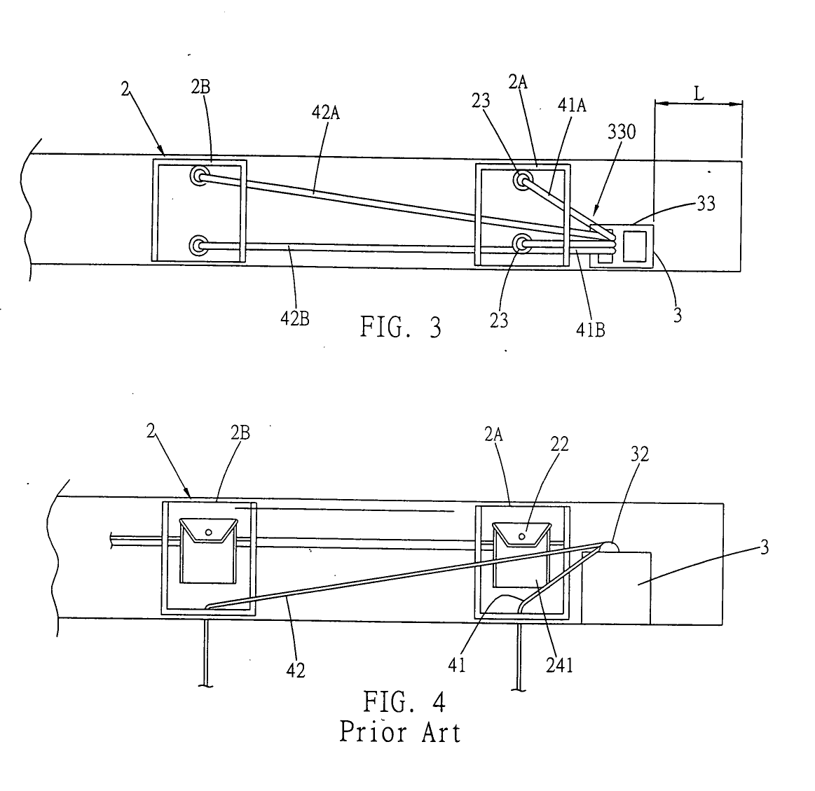

### DETAILED DESCRIPTION OF THE PREFERRED EMBODIMENTS

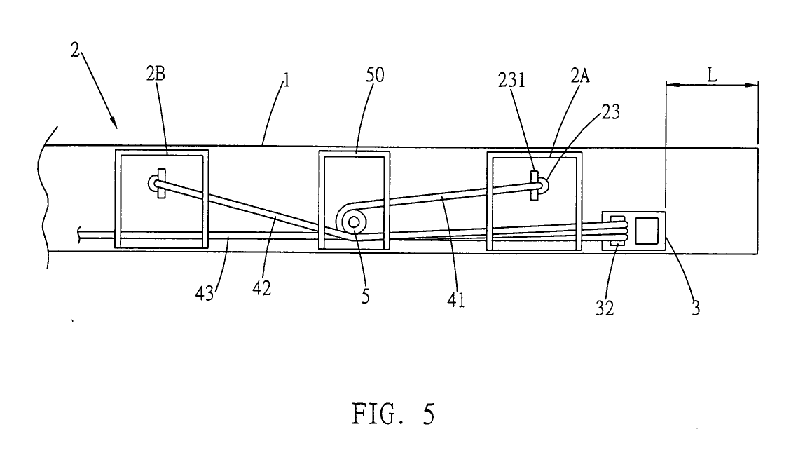

Referring to FIG. 5, a bending pulley 5 is located between a first seat 2A and a second seat 2B installed in a top rail 1. The bending pulley 5 can be installed at a proper position in a bottom of the top rail 1 with any method, or can be indirectly installed with a connection seat 50.

An arresting member 3 is located at a position close to a side of the first seat 2A, so as to reserve a maximum cutting length L.

A first pull cord 41 passing out of the first seat 2A is turning back through a sliding member 231, and enters into the arresting member 3 after bending through the bending pulley 5.

Free ends of a second and a third pull cords 42, 43 are accumulated and pass into the arresting member 3, and then pass out of the arresting member 3 through a turning pulley 32. As a passage of the first pull cord 41 is changed through the bending pulley 5, an entrance angle will be almost perpendicular to the turning pulley 32 installed in the arresting member 3, and thus is free from a mechanic interference caused by a large angle of a conventional application.

By mainly using the bending pulley 5, the present invention can enable a longer passage of the first pull cord 4 between a through-hole 23 of the first seat 2A and the arresting member 3, so as to absorb mechanical vibration energy during a pulling process by the longer passage. In addition, a change of curvature of the passage can provide a longer reaction length, so as to create a significant smoothing function during a process of pulling and retracting curtains.

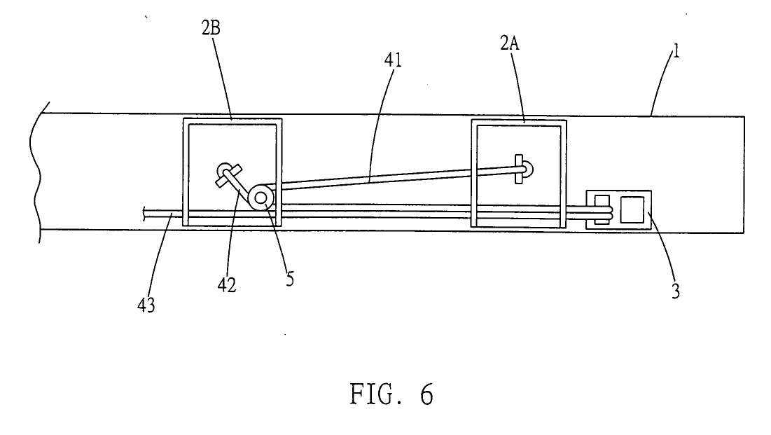

Referring to FIG. 6, the aforementioned bending pulley 5 can also be installed at an inner corner of the second seat 2B, so as to extend a turning back of the first pull cord 41 passing out of the first seat 2A, and finally to enable the first pull cord 41 to enter into the arresting member 3 along with the second and third pull cords 42, 43.

A passage angle of the second pull cord 42 of the second seat 2B can also be changed through a function of the bending pulley 5, enabling the second pull cord 42 to enter the arresting member 3 at a same angle with that of the first pull cord 41.

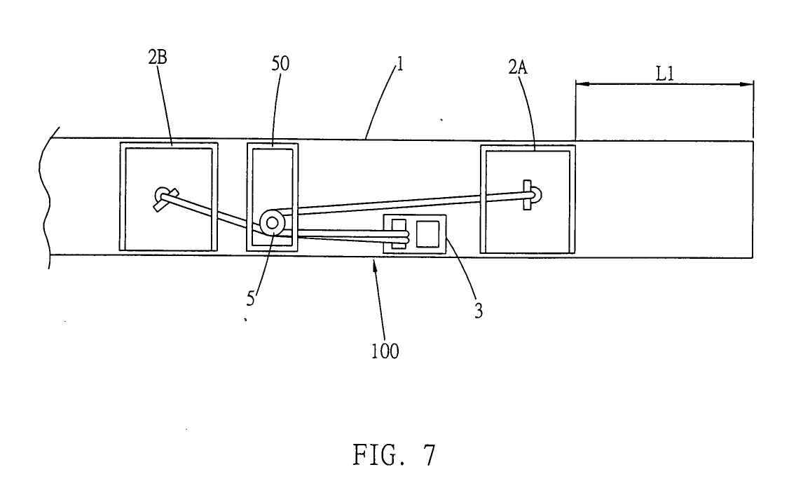

Referring to FIG. 7, as there is no restriction to a distance between the bending pulley 5 and the arresting member 3, the arresting member 3 can be located between the first seat 2A and the second seat 2B, on a side 100 in the top rail 1 facing an interior of a room, so as to reserve a longer cutting length L1. In addition, this change of installation position of the arresting member 3 is a totally revolutionary installation method, which provides a cutting length composed of every space except the position of the first seat 2A.

The bending pulley 5 can also be installed in the same way as shown in FIG. 6, or can be indirectly installed in the top rail 1 with the connection seat 50.

Referring to FIG. 8, to further enable a smooth pulling operation to the entire pull cord, an open ring 6 is installed on a top of the through-hole 23 at a bottom of the seat 2. A plurality of sets of slots 60 corresponding to multiple angles are formed on a top surface of the open ring 6, in order to install a shaft-shape sliding member 231 depending on the angle; therefore, the pull cord 4 can be sliding vertically to avoid impedance in a slant direction due to a requirement of pulling angle.

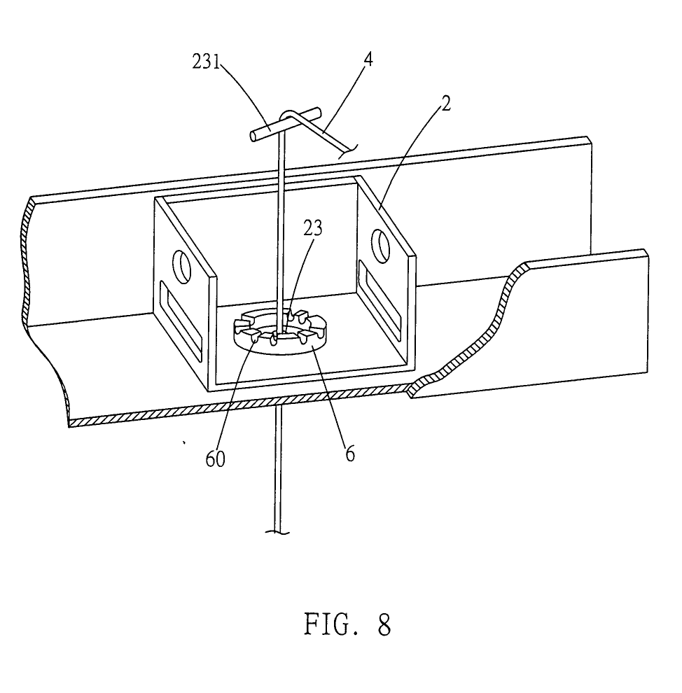

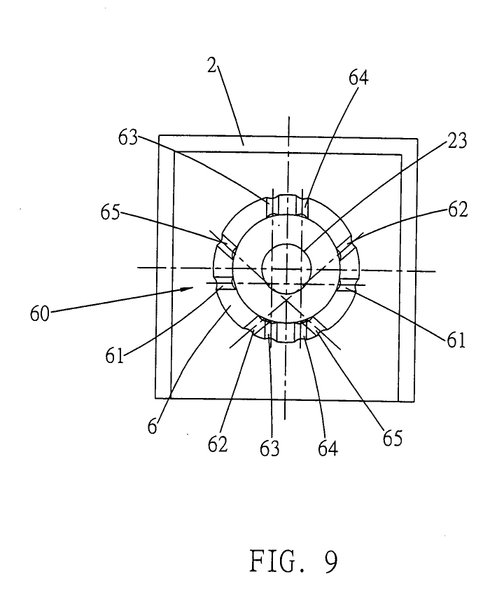

Referring to FIG. 9, it shows a top view of the seat 2 in FIG. 8. Pluralities of sets of slots 61, 62, 63, 64, 65, according to multiple angles, are installed on a top surface of the open ring 6 above the through-hole 23. More sets of slots 60 can also be installed according to requirement of even more angles.

Referring to FIG. 10, after installing the shaft-shape sliding member 231 on the first set of slot 61, the sliding member 231 is opposed to the through-hole 23 in a direction of X-axis, so as to provide a pulling in −Y direction to the pull cord 4.

As the ring 6 is a circular body with an equal thickness T, and each set of slot 60 is of a same height and is located at a tangential position with an identical radius, a length D of each set of slot 60 will be the same; therefore, the shaft-shape sliding member 231 can be installed in any set of slot, with two sides of the sliding member embedded into the slot 60 at an equal distance.

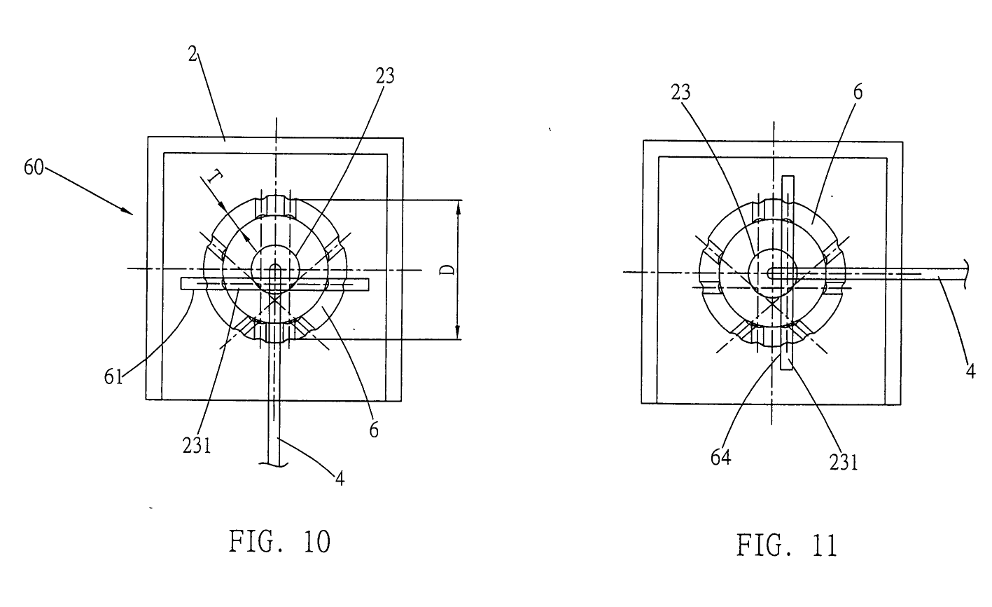

As shown in FIG. 11, if the shaft-shape sliding member 231 is installed on the fourth set of slot 64, a pulling in an X-axis direction will be formed to the pull cord 4 passing out of the through-hole 23.

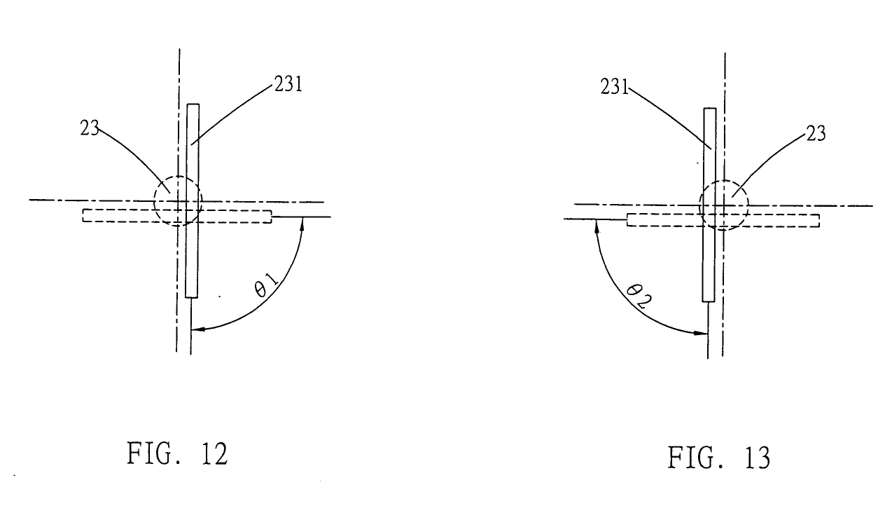

Referring to FIG. 12 and FIG. 13, according to a design of the aforementioned multiple sets of slots, a distribution along an X- and Y-axis can be formed between the shaft-shape sliding member 231 and the through-hole 23, and thus a range within an angle θ1 can be formed to provide a pulling to the aforementioned pull cord. Similarly, as shown in FIG. 13, if the shaft-shape sliding member 231 is installed at the other side of the through-hole 23, a range within an angle θ2 can be formed to provide a pulling to the aforementioned pull cord. By combining FIGS. 12 and 13, a plurality of pulling angles within at least 180 degrees can be provided.

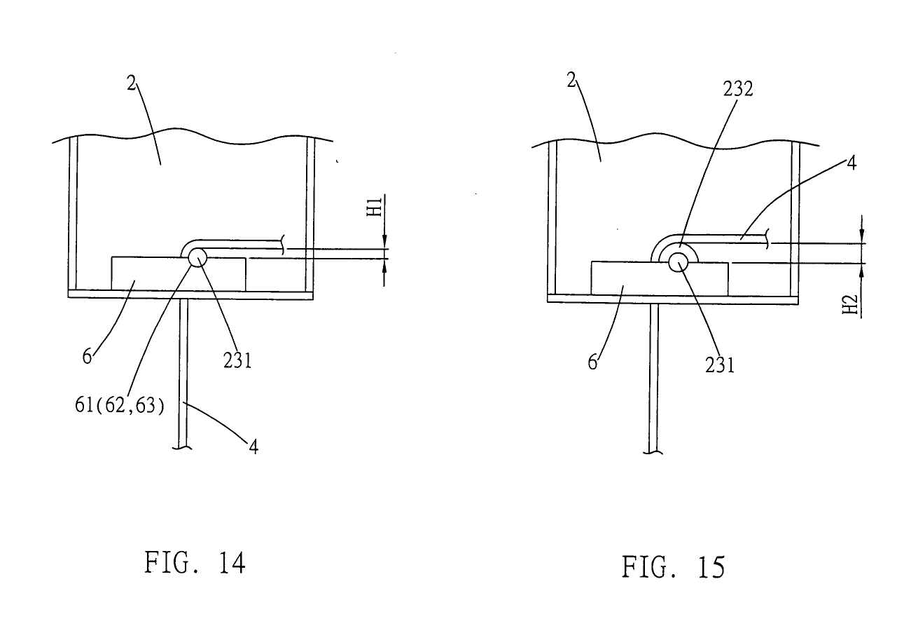

Referring to FIG. 14, the pull cord 4 passes through a bottom of the seat 2, and then enters into the shaft-shape sliding member 231 through a top end of the ring 6, which constitutes a height H1 between the top end of the sliding member 231 and the top end of the ring 6, in order to avoid an interference to the pull cord 4 passing out by the top end of the ring 6.

Referring to FIG. 15, if the shaft-shape sliding member 231 is embedded below the top end of the ring 6, a roller 232 can be indirectly installed at its outer circle in order to enlarge its range of radius, thereby increasing a height H2 of the pull cord 4 relative to the top end of the ring 6, and avoiding a mutual interference. A movable fitting assembling mechanism can be used between the roller 232 and the shaft-shape sliding member 231.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A pull cord activation passage mechanism for a window blind particularly for providing a reaction length of a longer curvature to an activation passage of pull cords for driving curtains of a horizontal blind which needs a reserved cutting length, which comprises primarily a top rail within which installed a plurality of seats for passing through the pull cords, with an end of the pull cord connected to curtains and a free end extended downward to form an active pull cord after accumulating the pull cord and passing it through an arresting member; the arresting member being installed between a first and a second seats, and a bending pulley being located at a side of the arresting member to provide a turning back to the first pull cord and to, enable the pull cord to enter the arresting member in a nearly perpendicular direction.

2. The pull cord activation passage mechanism for a window blind according to claim 1, wherein the bending pulley can be mounted inside the top rail with a connection seat.

3. The pull cord activation passage mechanism for a window blind according to claim 1, wherein the bending pulley can be directly located at a corner inside the second seat relative to a pulling passage of the pull cord.

4. The pull cord activation passage mechanism for a window blind according to claim 1, wherein the arresting member can be installed between the first and the second seats.

5. A pull cord activation passage mechanism for a window blind particularly for providing a pull cord to enter into a sliding member in a nearly perpendicular direction in a passage of activation of the pull cord for driving curtains of a horizontal blind, which comprises primarily a top rail within which installed a plurality of seats for passing through the pull cords, with an open ring located above a through-hole at a bottom of the seat; a plurality of sets of slots corresponding to requirement of angles of passage of activation of the pull cords being located at a top end of the ring, for installing shaft-shape sliding members according to the angle of activation of the pull cords, wherein the ring is in a circular shape and two sides of each shaft-shape sliding member can be installed at an equal distance.

6. The pull cord activation passage mechanism for a window blind according to claim 5, wherein each set of slot is at a tangential position with an identical radius.

7. The pull cord activation passage mechanism for a window blind according to claim 5, wherein a roller with a larger diameter can be formed at a waist of the shaft-shape sliding member.

8. The pull cord activation passage mechanism for a window blind according to claim 7, wherein a relative free rotation can be made between the roller and the shaft-shape sliding member.
